(19) United States
(12) Patent Application Publication
(10) Pub. No.: US 2006/0265399 A1
(43) Pub. Date: Nov. 23, 2006

(54) KEYWORDS AUTO-SEGMENTATION AND AUTO-ALLOCATION SYSTEM TO INCREASE SEARCH ENGINES INCOME

(76) Inventor: Giotto De Filippi, Milano (IT)

Correspondence Address: F. RHETT BROCKINGTON, 10613 KENNEL LANE, CHARLOTTE, NC, 28277, US

(21) Appl. No.: 11/382,276

(22) Filed: May 9, 2006

(30) Foreign Application Priority Data
May 23, 2005 (IT) MI2005A000933

(51) Int. Cl. G06F 17/30

(52) U.S. Cl. 707/10

(57) ABSTRACT

A system that automatically analyzes search queries made by visitors on search engines in order to automatically segment search queries and visitors in order to make the advertisements displayed by the search engines more targeted and so more valuable for the advertiser, and allow the search engine to increase the revenue related to advertisement sales and the advertiser to be more profitable.

### CROSS REFERENCE TO RELATED PATENT APPLICATION

The application claims the benefit of the priority foreign filing date of the utility patent application bearing the application serial number MI2005A000933 filed in Italy on May 23, 2005.

### BACKGROUND OF THE INVENTION

1. Field of the invention

The present invention is related to search engines and more specifically to a method for optimizing advertising revenue for search engines.

2. Prior Art

Search engines allow visitors to search for information on the Internet. The visitor types in some keywords he is interested in, and the search engine researches in it's database of web pages or other documents the pages that are more relevant to the search query provided by the visitor.

In the beginning technological phases of the commercial utilization of the Internet search engines revenue was derived from a type of advertisement that is called “banners”, which appeared on the different web pages of the search engines and these banners were not targeted. A visitor that was searching for example for cat food, might see an advertisement for weight loss.

A further improvement in the world of Internet advertising was targeted advertisements where according to what the visitor searched, the advertisements were tailored to the visitor's search queries. This process comprised having advertisers bid a certain amount of money for keywords they were interested in. So for example if a visitor searched for “dog”, the search engine would display all the advertisements relevant to the search query (if there was enough space on the page) or only the advertisements relevant to the search query of the advertisers that paid the most (if there was not enough space on the page) sorted by their bid amount.

The more the advertiser bid, the better his position on the page will be. The bid is per click. The advertiser actually pays only when his ad is clicked, and not when the ad is displayed.

The next evolution of this system was made by taking into account other components than just the bid amount per click. For example assume that an advertiser has a very poorly constructed advertising message, and another advertiser has a very compelling advertising message. The compelling advertisement will be clicked a lot more. However, if the advertiser with the poor advertisement (that does not result in many clicks from visitors) is bidding a larger amount, he'll have a better position on the page.

This latter system does not maximize the revenue of the search engine, since it may display in the best positions advertisements of advertisers that are not receiving many clicks. So, if advertisers with poorly constructed advertising messages are paying more per click than advertisers with compelling messages, since advertisers with poorly constructed advertising messages are receiving very few clicks, they are less profitable for the search engine than advertisements of advertisers with compelling messages that are paying less per click, but receiving much more clicks, since the amount of money the search engine receives is the bid amount per click (or the difference between the bid amount and the competitor's bid amount that is just below if they use proxy bidding) multiplied by the number of clicks received.

The next step in the development was to track the click-through-rate (CTR), as well as the bid amount. The search engine will then display the advertisements not in order of bid amount only, but in order of bid amount multiplied by CTR. So for example an advertisement where the advertiser is paying $1.00 per click, and that is clicked 1% of the time, will have a less good position on the search engine's results page compared to an advertisement where the advertiser is paying $0.50 but that advertisement is clicked 4% of the time. Because $1.00 * 1%=$0.01 (So the revenue of that advertisement for the search engine is $0.01 per impression) compared to $0.50 * 4%=$0.02 (revenue of $0.02 per impression).

Other criteria have been developed, for example the idea of adding negative keywords, which means that if the keyword defined as negative by the advertiser is present in the search query, the advertisement should not be displayed. The purpose negative keywords is to reduce the number of impressions where it's not useful, so that the CTR can increase and the advertisement gets a better position where it's relevant. Consider for example a shop that sells books, the advertiser can use as a negative keyword, “free” because it's very unlikely that people looking for “free books” will buy books. The advertiser sets “free” as a negative keyword and he will get less impressions for his advertisement message. This will save the advertiser money because he won't have to pay for someone searching for free books: he will save money on the clicks that could have come from people that used the keyword “free” (which are very likely to be of little value to the advertiser), but also because since the number of clicks should stay around the same (low chances that people looking for free books click on the advertisement of a book store) the CTR will improve (he will get the same number of clicks from the targeted visitors and less impressions) so the price the advertiser has to pay to get the same position on the search engine results page will be lower, and this will allow him to make more profit, bid a larger amount where he is profitable, and leave space for other advertisers to bid more where it's more profitable for them than for him. The search engine will make more profit as the allocation leaves space for other advertisers and also since the advertiser is profitable, he won't stop the advertising campaign.

Other techniques have been developed that allow the advertiser to segment the searches by adding specific matching conditions to his keywords. Examples of the current matching conditions are the following:

(1) If the search query match the keywords defined by advertiser, no matter if there are more words in the search query, and no matter the order. For example search query “blue dog in the room” will match advertiser keyphrase “room dog”;

(2) If the search query match the keywords defined by advertiser in same order. For example search query “my blue cat is on the table” will match the keyphrase “blue cat” but will not match keyphrase “cat blue” and will not match “blue table”;

(3) If the search query is exactly the same as the keywords defined by advertiser. So for example “nice dog” will match only search query “nice dog”.

These improvements are useful in allowing advertisers to improve the effectiveness of their campaigns, and in increasing the revenue of the search engines that use them. A few examples are illustrative. Assume an advertiser selling “cat food” discovers that he is performing very well in terms of clicks received when visitors just search the exact phrase “cat food”, but less well when people are searching it with other phrases, like “nice cat food”. If the advertiser knows how to use all the tools that a search engine provides him, he can make distinct matching rules for different keywords groups: one for all the words in any order, no matter if other words between them, no matter if there are other words before and/or after them; one for all the words in order, no matter if there are other words before and/or after the phrase; and one for the exact phrase. The matching criteria help preserve the effectiveness of keywords for a given matching criteria. Assume for example that an advertiser is getting a very good CTR for “cat food” (exact search) and a much lower CTR when there are other words in addition to “cat food” in the search query. By not telling the search engine to count the CTR in a separate way for all the ways of matching the keywords will result in dilution of the CTR. So if advertiser is not segmenting and he is getting very high CTR for the exact term, and very low CTR for the term with some other words around, the search engine will not make the distinction automatically and the advertiser will have an average CTR for both. The net result will be that the search engine will lose revenue because for example advertiser could lose money on the overall so he'll stop the campaign, even if he would be making money (and so he would not stop the campaign) if he was promoting his website with only the exact matching in this example.

Also geographical targeting has been introduced, so an advertiser can choose to display his advertisement for example only in a given country, only in a given state, or in a given city, etcetera. This is very useful because an advertiser might make money in some areas, and not in other areas, so he'll choose the areas where he makes more money. However, this means assuming that the advertiser knows exactly where he'll get the best market reaction to his products. Let's assume that an advertiser from Europe, that knows nothing about the United States, wants to target his advertisement in all the United States. He makes good sales, but he is spending too much money on advertising compared to the money he makes, so he gives up, and stop the advertising campaign (and the search engine stop making money from him). What he did not know in this example is that only in 2 states visitors were clicking on his ad. If the advertiser had known this, he would have targeted his advertisement to these two states only, and so he would have spent much less on advertisement (let's remember that even if in the other states visitors were not clicking on the advertisement, still they were generating impressions of this advertisement, so the CTR of the advertisement was lower compared to what it could have been if the advertisement would have been displayed only in the 2 states where visitors were clicking it, and the price the advertiser had to pay to appear on the search engine was higher because the search engine keeps into account not only the bid price but also the CTR) and so he would have continued the campaign, and the search engine would have made more money.

The problem currently is that the search engine will not automatically segment the location of the search queries. The search engine will segment only by what the advertiser has defined. So if advertiser define “United States” and he get clicks only from one State, the very good CTR he would be getting from that state will be diluted with the very bad CTR he would be getting by the other states, and the advertiser will probably abandon the campaign. The search engine asks the advertiser to decide where he wants his campaign to appear, and does not automatically segment by geographical locations.

### SUMMARY OF THE INVENTION

A system and method for automatic segmentation of all the factors that are pertinent in terms of targeting an advertisement displayed by a search engine. Segmentation factors include, but are not limited to keywords searched by visitor, geographical location of visitor, the local time of visitor and other information as available about the visitor. The system and method for automatic segmentation is used to better allocate advertising space so as to increase the search engine's revenue. The invention also enables the allocation of unused or poorly used advertising space with specific agreements with the advertiser, where the search engine takes a commission instead of a payment per click, and to have third parties write more compelling advertisements for advertisers so to increase the revenue for both the advertisers and the search engine.

### DEFINITIONS

Keyword: A word that is used in a search query by visitors in order to find relevant documents related to this word. For example if I want to find webpages related to “dogs”, I'll make a search query on the search engine with the keyword “dogs”. For the purpose of this document when I refer to “Keyword” I am referring to both “Keyword” and “Keyphrase”.

Keyphrase: A group of keywords that are used in a search query by visitors in order to find relevant documents related to this group of words. For example if I want to find webpages related to “nice dogs”, I'll make a search query on the search engine with the keyphrase “nice dogs”.

Search query: A request made to a search engine to retrieve documents related to the keyword provided.

Search engine: A system designed to search information on the Internet. The search engine must be provided with keywords, and will return documents relevant to the keywords provided. Some examples of search engines are MSN™, Google™ Yahoo™.

Visitors: People browsing the search engine website and performing search queries in order to receive relevant documents related to the keywords they provided.

Targeting: In advertising targeting means displaying advertisements appropriately according to the group that will receive the advertisement.

Advertiser: The person/company that is paying the search engine to display their ads

CTR: Click-through rate: The ratio usually expressed in percentage of clicks versus the number of impressions. Obtained by dividing the number of clicks by the number of impressions. Example: 1 click for 100 impression means a CTR of 1%.

Impression: The act of having an advertisement be displayed to a visitor. Every time the advertisement is displayed to a visitor, an impression in generated.

Click fraud: When a click is made by a person or automated program whom is not a visitor really interested in the product for sale on the advertiser's website, and for the only purpose to have the advertiser pay for the click.

Banners: An image that is displayed on a website for the purpose of having visitors see it and click on it.

Creatives: The text, image, video or audio that is displayed as an advertisement

Creative Person: A person that will design creatives.

Conversion: When the visitor makes the action desired on the website of the advertiser, for example the visitor buys the product.

Conversion rate: Number of conversions made compared to the number of clicks received expressed in percentage (Calculated doing: number of conversions divided by clicks received)

MOPC: Maximum offer per click. The maximum price the advertiser is willing to pay to receive a click on his advertisement, coming from a visitor that has made a search query with a given keyword on a search engine, and to bring the visitor on his site. Also called maximum bid amount.

CPC: Cost per click (It's a cost for the advertiser, an income for the Search Engine), the price the advertiser pays to receive a click on his advertisement, coming from a visitor that made a search query with a given keyword on a search engine with the purpose to make the visitor come on his website.

ACPI: Average cost per impression (It's a cost for the advertiser, an income for the Search Engine). ACPI is calculated by several methods.

For advertisers who pay per click, it is the CPC multiplied by the CTR.

For advertisers who pay by commission on conversions, it is the commission that an advertiser will pay expressed in percentage of the sales amount when a conversion is done by the visitor after clicking the advertisement displayed on the search engine, multiplied by the CTR multiplied by the conversion rate, multiplied by the average value of conversions (the average sales price).

For advertisers who pay by the impression, it is simply the cost that the advertiser pays per impression.

To segment: To condition the displaying of the advertisement to some conditions, so that to display the advertisement only when it has an improved chance of being clicked, resulting in an increase of the CTR

Segment: Group of possible search queries made by the visitors, grouped according to certain criteria that are applied to group the searches.

### DETAILED DESCRIPTION

The invention is a method of automatically optimizing allocation of advertisement impressions.

The method comprises having the advertiser define the keywords related to his website or having the search engine determine the relevant keywords by analyzing the advertiser's website. Having the search engine to automatically provide synonyms or related keywords if the advertiser wants to do so. Having the search engine generate impressions of the advertisement when in the search query there is a potential segment matching the keywords defined. Proceeding to a segmentation of the search query and estimating the CTR that can be obtained from every combination segment-advertisement and storing it to have the search engine generate impressions for the combinations segment-advertisement with the highest ACPI.

This component of the invented method can be applied independently and/or to traditional systems that are used today, and/or combined with the other components of the method described in this document.

In the current art the advertiser can choose the keywords for which he wants his advertisements to appear and he can define the following matching criteria:

(1) Exact keywords: The advertiser wants his ad to appear only for the search queries corresponding exactly to the keyword/s.

(2) Keywords in order: The advertiser wants his ad to appear only for the search queries where the keywords he defines are in the order he defines them (without words between them) but allows other words before and/or after the keywords.

(3) Unsorted keywords: The advertiser accepts any search query, as long as they contain all the keywords he defines, even not in order.

Advertiser can also define negative keywords, in this case the advertisement must not appear if at least one of these keywords is contained in the search query.

With this invention the segmentation can be done in the following ways or others:

Let's use the example of the advertiser's keyphrase “food dogs nice”:

The search queries will be segmented in the following segments:
(1) Exact sentence, in order, all the words.
   Example of a compatible search query: “food dogs nice”
(2) Different order, all the words.
   Example of a compatible search query: “food nice dogs”
(3) In order, all the words, accepting further words before and/or after.
   Example of a compatible search query: “buy food dogs nice”
(4) In order, all the words, even with other words inside the sentence.
   Example of a compatible search query: “food dogs blacks nice”
(5) Different order, all the words, even with other words inside the sentence.
   Example of a compatible search query: “dogs black food nice”
(6) In order, all the words, less a given number of words (in the example one).
   Example of a compatible search query: “food dogs”
(7) Different order, all the words, less a given number of words (in the example one).
   Example of a compatible search query: “dogs food”
(8) In order, all the words, accepting further words after and/or before, less a given number of words (in the example one).
   Example of a compatible search query: “food dogs black”
(9) In order, all the words, even with other words inside the sentence, less a given number of words (in the example one).
   Example of a compatible search query: “food big dogs”
(10) Different order, all the words, even with other words inside the sentence, less a given number of words (in the example one).
   Example of a compatible search query: “dogs big food”
(11) Single word extracted from the search query.
   Example of a compatible search query: “dogs”
(12) Single word extracted from the search query, accepting other words before and/or after.
   Example compatible search query: “black dogs”
(13) In order, all the words, accepting further words before and/or after, even with other words inside the sentence
   Example of a compatible search query: “buy food big dogs nice”
(14) In order, all the words, accepting further words after and/or before, less a given number of words (in the example one), even with other words inside the sentence
   Example of a compatible search query: “food big dogs black”
(15) Different order, all the words, accepting further words after and/or before
   Example of a compatible search query: “dogs food nice now”
(16) Different order, all the words, less a given number of words (in the example one), accepting further words after and/or before
   Example of a compatible search query: “dogs food now”
(17) Different order, all the words, accepting further words after and/or before, even with other words inside the sentence
   Example of a compatible search query: “dogs good food nice now”
(18) Different order, all the words, less a given number of words (in the example one), accepting further words after and/or before, even with other words inside the sentence
   Example of a compatible search query: “dogs good food now”

An example of how this method is an improvement over the current art.

Assume the advertiser has a website about dogs and he is selling dog accessories. He goes on the search engine, and provides as a keyphrase for his campaign “dog accessories”. Using the current art, the search engine will simply displays the advertiser's advertisement as long as the search query contains the word “dog” and the word “accessory”. If the advertiser is very marketing savvy he'll also organize the keyphrases in a way so that the CTR of the 3 matching methods that are available today (exact phrase, all the words in order, all the words no matter the order) are used, so that the CTR is accounted for every matching method, and not just for the whole.

For example on Google™ this is done this way:

For example on Google™ this is done this way:
Dog accessories [symbol] all the words no matter the order
“Dog accessories” [symbol] all the words in order
[Dog accessories] [symbol] exact phrase

If the advertiser is marketing savvy enough to do this, then the CTR will be accounted separately for the 3 matching methods, and so it won't be diluted if one matching method has a lower CTR than the others. Now let's assume that this website about dog accessories, is selling hundreds of accessories for dogs: food, jewelry, necklaces, clothes, toys, etcetera, however what visitors are really interested in (willing to click and to buy) is the dog necklaces only. The problem is that the search engine and the advertiser don't know that the only commercially successful product on this site is only the dog necklace. So according to the prior art, the advertiser will simply use as keywords: “dog accessories”. If the visitor searches “dog necklace”, the ad of this advertiser won't be displayed. Now let's imagine that after some weeks, the advertiser realizes that his ad is not displayed very much, so he decide to bid on the keyword “dog” (with the default matching on Google™, which is “broad mach” that is defined as: “all the words no matter the order, accepting further words before and/or after, even with other words inside the sentence”). Now what will happen is that when someone will search for “dog necklace”, the ad of this advertiser will be displayed (if he is paying enough), but the ads will be displayed also if someone search for “dog jewelry”, “dog food”, “dog toys”, etcetera The CTR will be accounted only for “dog”, so all the higher CTR of the more specific phrases will be diluted under “dog”. Now let's assume that 90% of the searches are for “dog toys” and 10% are for “dog necklace”. What will happen is that the advertiser will probably lose money because the good product he has is the dog necklace, but he is paying also the traffic for “dog toys” (that people search for fun for example, but do not click and buy). So he'll give up the campaign because it's not profitable. If however he had known that he could have made money by buying only the keyphrase “dog necklace”, he would have made money, and the search engine too. Now let's examine how the invented method would have made it profitable to both the advertiser and the search engine. Assume that the advertiser whom is not marketing savvy, will still use the keyphrase “dog accessories”.

When visitor searches for “dog necklace”, the search engine will test the advertisement of this advertiser, since it's part of the matching category: “In order, all the words, accepting further words after or/and before, less a given number of words (in the example one)”. So in this case “dog necklace” will match “dog accessories” according to the matching category “In order, all the words, accepting further words after or/and before, less a given number of words (in the example one)”. When a customer clicks this advertisement, the search engine will account it in all the possible matching segments, so to never dilute the CTR and to get as much CTR information as possible. Let's see some examples of how the CTR information will be stored, to ensure that on the next search the search engine will be able to display the advertisement that will generate the best revenue.
Exact sentence, in order, all the words [symbol] “dog necklace”
In order, all the words, less a given number of words (in the example one) [symbol] “dog”
In order, all the words, less a given number of words (in the example one) [symbol] “necklace”

On the next search query, the search engine will use this newly acquired information in order to display more profitable advertisements, since it stored this new CTR information.

So next time for example a visitor searches “necklace puppies” it'll be matched by the word “necklace” using the matching rule “In order, all the words, accepting further words before and/or after”. Then, the CTR of “necklace puppies” will be stored too, in all the possible matching segments, and used to increase the profitability of the advertisements.

The method can comprise the steps of identifying the geographic location of the visitor who performed the search query and matching it with a geographical segment. The geographical segment can have a tree structure with levels of increased specificity such as continents, countries, regions, cities, roads; or the geographical segment can have geographical coordinates of latitude, longitude and area size around these coordinates. Testing the advertisements of the advertiser on different geographical segments by extending or reducing the size of the geographical segment according to the performance of the advertisement being tested in terms of CTR, in order to find the segments with the highest CTR for this advertisement, estimating the CTR that can be obtained from every combination segment-advertisement and storing it to have the search engine generate impressions for the combinations segment-advertisement with the highest ACPI.

This component of the invented method can be applied independently and/or to traditional systems that are used today, and/or combined with the other components of the method described in this document.

The method identifies geographic areas having a good ACPI, even in areas where the advertiser would not have thought of. An example illustrates the method.

In the current art the advertiser must choose the geographical area where his advertising will be shown.

For example he defines United States, so that his advertisement will be displayed to the visitors from United States. The CTR will be calculated in a general way, and will not be segmented. Let's assume that most of the clicks are from Florida, so there would be a very good CTR if he was targeting only Florida, however he is targeting the whole United States. There are many searches from other states too, but not many clicks. So the CTR is diluted, because the search engine does not keeps track of the geographical area where the visitor is coming from, it simply records the CTR information as long as the ad is displayed. So in this example where Florida visitors generate a good CTR, but the rest of the United States does not, the advertiser might decide to stop the campaign because it's too expensive for him (since the CTR is diluted to the whole United States area). So even if he would have been profitable targeting only Florida (but he didn't know) he will stop the campaign, since its' not profitable for him to target all the United States.

In the invented system however, when the search engine records the CTR, it also records the geographical location (i.e., as a latitude/longitude, or in a tree structure) Then the CTR is estimated for all the compatible levels, so for example if a search is made by a visitor from Miami, the CTR will be recorded for Miami, but also for Florida, for United States and for North America. This is also done with Latitude/Longitude by recording the exact coordinates of the visitor location, and then expanding the area around that point to estimate different CTR values. When a search is made, the search engine will check the CTR according to the compatible areas, and decide if it's profitable or not to display an advertisement and in which order to display them. So the search engine, after testing different geographical areas and recording the CTR will display the advertisements where it's more profitable (In our example in Florida). So the search engine will display the advertisement only in Florida even if the advertiser did not know that his advertisement had a good CTR only in Florida (he did choose “United States”), so he will profit from this and the search engine too.

The method can also include using time segments, where each time segment is a local time period during which the advertiser's impression will be generated. Determining the local time of when the search query is performed. Segmenting time by units such as night, morning, working hours, afternoon or simply ranges of hours, like from 2 PM to 3 PM, or from 1400 hrs to 1600 hrs. Calculating the influence of the time on the CTR so to display the advertisements with the highest ACPI.

This component of the invented method can be applied independently and/or to traditional systems that are used today, and/or combined with the other components of the method described in this document.

An example of how time segmentation enhances the efficacy of a campaign follows. An advertiser wants to display his ad for “night clubs”, but he realizes that it is not profitable. The reason is that the advertisement is displayed all the day long. During the day people see this ad, but they do not click it, however during the night they click because they are interested into going to the night club. The CTR would then be diluted making the cost higher for the advertiser, and not profitable for advertiser, so he'll stop the campaign. With the invented method however, the search engine will segment the visitor's local time into time segments, for example day and night, so the CTR will not be diluted and the search engine will display this advertisement only when it's most productive.

Time segmentation can be applied to both the traditional systems, and as a component of the invented method.

The invented method can further comprise the step of generating a user classification segment, where each user classification segment is a set of criteria comprised of: the visitor's purchasing frequency, amount of purchases, categories of purchases, and other purchasing preferences.

By segmenting the visitor the search engine can determine what will be the advertisement with the highest ACPI for the search query considering the classification of the visitor, so to display the advertisements with the highest ACPI.

Visitor classification segmentation can also be used to avoid click fraud (where with some mechanisms it's possible to simulate a large number of clicks to create damage to competitors) by distinguishing visitors with a real activity, and users with a fraudulent activity (who never (or almost never) buy, and only click).

This component of the invented method can be applied independently and/or to traditional systems that are used today, and/or combined with the other components of the method described in this document.

An example of the method follows. Let's imagine an advertiser is the owner of an online shop that sells the usual stuff one can find in supermarkets (fruit, meat, pasta, fish, cheese, etcetera). Only people that buy a lot on the Internet will buy this kind of product that is easily accessible locally. This is really the last thing one would buy on the Internet, so we can expect people that already buy a lot of things on the Internet (books, computers, hard to find items) are more likely to buy these kind of products. The search engine will store the CTR according to data about the visitor (in this example segmented by number of purchases) and will then display this advertisement for the online supermarket to users who have a record of making a lot of purchases on the Internet.

The method further includes the step of defining a mutual business relationship between the advertiser and the search engine. The advertiser can add the search engine's control codes on the confirmation pages of the orders. This way it's possible to measure the quantity of orders that arrive from the search engine site, and the search engine takes a percentage from the advertiser when the conversion gets done. This percentage on the conversion becomes a variant of the pay per click payment, to decide which advertisements to display and how to sort them, the search engine will calculate the ACPI using the case of the payment in percentage of conversions, explained in the definition of ACPI. In case the search engine provider wants to protect itself more, instead of asking the advertiser to insert a control code it could do the processing of the payment itself, or make an agreement with a company that makes payment processing. This further step allows the search engine to maximize the income, displaying advertisements even when a few or none would be ready to buy space. The search engine accepts to make money in percentage, removing all risks from the advertiser.

This component of the invented method can be applied independently and/or to traditional systems that are used today, and/or combined with the other components of the method described in this document.

An example follows. An advertiser has a product to sell, but he is very risk adverse and does not want to spend any money in advertising. He partners with the search engine. The advertiser agrees to pay to the search engine provider 5% of the gross amount of the sales coming from visitors that found his website from the search engine. He'll get a special code to put on his order confirmation webpage, so that the search engine provider will be notified when a sale is made and the search engine will be able to check if the visitor that purchased previously clicked on the advertiser's advertisement on the search engine's website. If this is the case the search engine will receive 5% of the value of the sale. The advertiser will have no interest in cheating the search engine, because if the search engine is making less money from him than from a competitor using the same method, the competitor will get better positioning and so more sales.

The method can further comprise the step of defining a mutual business relationship between the advertiser, a creative person and the search engine. This enables a creative person to subscribe to a section of the search engine site for the purpose of designing advertisements on a performance based relationship. According to the willingness of the search engine and of the advertiser, the creative person can prepare copy that the advertiser can use.

Once an advertising message is created one or more advertisers can approve it or not. In case it's approved, the results will be recorded (the CTR) so that both the creator and the advertiser can see the CTR. The creator can be paid both with a fixed value, or in percentage, or in other ways. The results of the past work of a creative person could be visible to the advertisers, making a sort of “curriculum vitae”. This way the more a creative person is good at getting high CTR, the more he will be used by the advertisers. The amount spent by an advertiser could be visible to the creative people. This way it'll be possible to allocate the best creative people (the ones that in the past obtained the highest CTR) to the advertisers that spend the most, so to maximize the efficiency of the creative people.

This component of the invented method can be applied independently and/or to traditional systems that are used today, and/or combined with the other components of the method described in this document.

An example follows. Instead of having the advertiser writing his own ads, a creative person who is marketing savvy will make a better advertisement for the advertiser, that will get a better CTR rate. After the advertiser approves it, the advertisement is shown. The creative person will be paid based on the agreement stipulated.

What is claimed is:

1. A method of automatically optimizing allocation of advertisement impressions, said method comprising:
providing defined keywords related to the website generated by the advertiser or the search engine following analysis of the advertiser's website to determine the relevant keywords;
having the search engine to automatically provide synonyms or related keywords if the advertiser wants to do so;
having the search engine generate impressions of the advertisement when in the search query there is a potential segment matching the keywords defined;
proceeding to a segmentation of the search query and estimating the CTR that can be obtained from every combination segment-advertisement where the set of criteria are comprised of: exact sentence in order with all the words present; all the words in different order; all the words in order, accepting further words before and/or after; all the words in order, even with other words inside the sentence; all the words in different order, even with other words inside the sentence; all the words in order less a given number of words; all the words in different order, less a given number of words; all the words in order, accepting further words after and/or before, less a given number of words; all the words in order, even with other words inside the sentence, less a given number of words; all the words in different order, even with other words inside the sentence, less a given number of words; single word extracted from the search query; single word extracted from the search query, accepting other words before and/or after; all the words in order, accepting further words before and/or after, even with other words inside the sentence; all the words in order, accepting further words after and/or before, less a given number of words, even with other words inside the sentence; all the words in different order, accepting further words after and/or before; all the words in different order less a given number of words accepting further words after and/or before; all the words in different order, accepting further words after and/or before, even with other words inside the sentence; all the words in different order, less a given number of words, accepting further words after and/or before, even with other words inside the sentence; and other possible segmenting combinations;
storing the CTR that can be obtained from every combination segment-advertisement;
having the search engine generate impressions for the combinations segment-advertisement with the highest ACPI; and
optionally, correlating this information with other segments: geographical area, timeframe, user classification, previous search queries and/or other possible segments.

2. A method of automatically optimizing allocation of advertisement impressions, said method comprising:
identifying the geographic location of the visitor who performed the search query and matching it with a geographical segment, wherein said geographical segment has a tree structure with levels of increased specificity such as continents, countries, regions, cities, roads; or said has geographical coordinates of latitude, longitude and area size around these coordinates; or said geographical segment has both tree and geographical coordinates;
testing the advertisements of the advertiser on different geographical segments by extending or reducing the size of the geographical segment according to the performance of the advertisement being tested in terms of CTR, in order to find the segments with the highest CTR for this advertisement;
estimating the CTR that can be obtained from every combination segment-advertisement and storing it to have the search engine generate impressions for the combinations segment-advertisement with the highest ACPI; and
optionally, correlating this information with other segments: keywords, timeframe, user classification, previous search queries and/or other possible segments.

3. A method of automatically optimizing allocation of advertisement impressions, said method comprising:
determining the local time of when the search query is performed;
segmenting time by units such as night, morning, working hours, afternoon or simply ranges of hours, like from 2 PM to 3 PM, or from 1400 hrs to 1600 hrs;
calculating the influence of the time on the CTR of the advertisement so to display the advertisements with the highest ACPI; and
optionally, correlating this information with other segments: geographical area, keywords, user classification, previous search queries and/or other possible segments.

4. A method of automatically optimizing allocation of advertisement impressions, said method comprising:
generating a user classification segment, where each user classification segment is a set of criteria comprised of: the visitor's purchasing frequency, amount of purchases, categories of purchases, and other purchasing preferences;
determining what will be the advertisements with the highest ACPI for the search query by segmenting the visitor considering the classification of the visitor, so to display the advertisements with the highest ACPI;
optionally, correlating this information with other segments: keywords, geographical area, timeframe, previous search queries and/or other possible segments; and using visitor classification segmentation to avoid click fraud.

5. A method of automatically optimizing allocation of advertisement impressions, said method comprising:
defining a mutual business relationship between the advertiser and the search engine;
giving to the advertiser the ability to add the search engine's control codes on the confirmation pages of the orders;
measuring the quantity of orders that arrive from the search engine site, and having the search engine takes a percentage from the advertiser when the conversion gets done; and
calculating the ACPI using the case of the payment in percentage of conversions, explained in the definition of ACPI, so to display the advertisements with the highest ACPI.

6. A method of automatically optimizing allocation of advertisement impressions, said method comprising:
defining a mutual business relationship between the advertiser, a creative person and the search engine;
enabling a creative person to subscribe to a section of the search engine site for the purpose of designing advertisements on a performance based relationship;
enabling the creative person to prepare copy that the advertiser can use, according to the willingness of the search engine and of the advertiser;
allowing one or more advertisers to approve the advertising message once it's created;
recording the results (the CTR) so that both the creator and the advertiser can see the CTR; in case the advertisement is approved;
having the creator being paid both in a fixed value, or in percentage, or in other ways;
making the results of the past work of a creative person visible to the advertisers, making a sort of “curriculum vitae”; and
making the amount spent by an advertiser visible to the creative people.
